(19) United States
(12) Patent Application Publication
(10) Pub. No.: US 2025/0052639 A1
(43) Pub. Date: Feb. 13, 2025

(54) METHOD FOR DETECTION AND MEASUREMENT OF SEAT LEAKAGE IN A VALVE

(71) Applicant: Karthik Udayakumar, Chennai (IN)

(72) Inventor: Karthik Udayakumar, Chennai (IN)

(73) Assignee: Karthik Udayakumar, Chennai (IN)

(21) Appl. No.: 18/797,566

(22) Filed: Aug. 8, 2024

Related U.S. Application Data
(60) Provisional application No. 63/518,116, filed on Aug. 8, 2023.

(51) Int. Cl. G01M 3/30

(52) U.S. Cl. CPC G01M 3/30

(57) ABSTRACT

Embodiments of the present invention provide a method for detecting and measuring seat leakage in valves during air or gas seat tests. The method involves sealing the valve openings and filling the cavity on one side of the closed valve with water. Pressurized air or gas is introduced to the opposite side of the valve, causing any leaks in the valve closure to generate bubbles that displace water through a conduit, forming drops that are collected in a container. The leakage is quantified by counting the drops or measuring the water volume in a graduated container.

### CROSS REFERENCE TO RELATED APPLICATION

The present non-provisional application claims the benefit of priority to provisional patent application No. 63/518,116, filed on Aug. 8, 2023, entitled “A METHOD FOR DETECTION AND MEASUREMENT OF LEAKAGE IN VALVE TESTING”, the entire contents of which are hereby expressly incorporated by reference.

### TECHNICAL FIELD

The present invention relates generally to a valve testing system and method, and more specifically to a system and method for measurement of leakage during pneumatic test of valves.

### BACKGROUND ART

Valves are critical components in various industrial applications, including pipelines, chemical processing, and water distribution systems. The proper functioning of valves is essential to maintain system integrity and operational safety. Leakage in valves can lead to significant operational inefficiencies, safety hazards, and increased maintenance costs.

Valves undergo various tests to verify compliance with leakage requirements outlined in industrial standards established by recognized standards organizations. These tests employ either air or water as the testing medium. One crucial test is the seat closure test, where air or gas serves as the testing medium. During this test, the valve's disc is closed, and air is filled through one end until a specific pressure is attained. Concurrently, the leakage through the seat is measured at the opposite end of the valve.

The existing technique for detecting leaks employs a conduit that connects a water-filled jar to the non-pressurised side of the valve under test (VUT). When leakage occurs through the valve disc's seat, it travels via the conduit and creates bubbles within the jar, allowing the quantity of the leak to be measured by counting these bubbles. While this approach is the one recommended by standards, the accuracy of leak measurements obtained using this method is compromised due to uncertainties arising from temperature variations in the testing environment. The pneumatic seat closure test is typically conducted subsequent to the hydrostatic test. The air trapped within the valve cavity may have temperature variation with the surrounding environment. Throughout the testing process, as the ambient temperature increases, the temperature of the air inside the valve cavity also rises. This increase in air temperature results in an expansion of air volume, creating a virtual leak that masks the actual leakage. In some instances, this can falsely indicate that a perfectly functional valve is leaking, or a leaking valve gets passed, thus rendering the test method itself invalid. Another alternative method involves filling water on the opposite side of the VUT, resulting in bubble formation when the valve seat leaks. However, this method is unsuited for test benches where both sides of the valve are typically closed.

Traditional methods for detecting and measuring valve leakage are often limited in accuracy, efficiency, or practicality.

The present invention provides a simple yet reliable method for detecting and measuring leakage. The proposed technique utilizes the fluid displaced by the leakage through the valve seat into the non-pressurized side of the valve to detect and quantify the leak.

### OBJECTS OF THE INVENTION

Some of the objects of the invention are as follows:

An object of the present invention is to provide a method for seat testing of valve.

Another object of the present invention is to remove uncertainties arising due to temperature variation in a valve testing environment.

Another object of the present invention is to provide a method of testing seat leakage in a valve that prevents false results.

### SUMMARY OF THE INVENTION

According to a first aspect of the present invention, a method for detecting and measuring seat leakage of a valve is provided. The method comprising: mounting a first open side of the valve on a first blind flange, the first blind flange has a passage for introducing pressurized air on the first open side of the valve; clamping a second blind flange over the second open side of the valve to seal the second open side; closing the valve to prevent flow from the first side to the second side; filling a cavity on a second open side of the valve with water; connecting a container to the second open side of the valve using a conduit through an opening in the second blind flange, the conduit is filled with water; increasing the pressure of air in cavity on the first open side of the valve to a predetermined amount; observing and counting the water drops as a result of leakage in the seat, where the bubbles created due to leakage in the seat displace the water in the conduit and form drops at the end of the conduit.

In one embodiment of the invention, the conduit is filled with water up to the point where the leakage measuring container is located.

In one embodiment of the invention, when the pressurized air leaks past the valve, bubbles are formed due to water present over the disc.

In one embodiment of the invention, the bubbles cause the water to displace and pushed the water through the conduit.

In one embodiment of the invention, the displaced water creates drops at the end of the conduit, the drops are collected in the container.

In one embodiment of the invention, drops are counted visually or using an instrument to measure the leakage in drops per minute.

In one embodiment of the invention, the measurement of the overall volume of leakage is performed using a graduated container.

According to a second aspect of the present invention, an apparatus for detecting and measuring a seat leakage of a valve is provided. The apparatus comprises: a first blind flange for sealing a first opening on a first side of the valve; a second blind flange for sealing a second opening on a second side of the valve, wherein cavity in the second opening at the second side of the valve is filled with water; a passage in the first blind flange to introduce pressurized air on the first side of the valve; a pressure system connected to the passage for increasing the pressure of air to a predetermined amount; a container connected to the second side of the valve using a conduit through an opening in the second blind flange, the conduit is filled with water; wherein seat leakage results in the formation of bubbles that displaces the water and form drops at the end of the conduit.

In one embodiment of the invention, the valve comprises a stem to put the valve in closed state.

In one embodiment of the invention, the first blind flange and the second blind flange seals the valve when the valve is in closed state.

In one embodiment of the invention, the second blind flange is clamped at the second side of the valve mechanically using a fastener or hydraulically.

In one embodiment of the invention, the drops at the end of the conduit are measured to determine the seat leakage of the valve.

In the context of the specification, when an element is referred to as being “fixed to” or “disposed to” another element, it may either directly on another element or indirectly on that other element. When a component is said to be “connected” or “connected to” another component, it may be directly connected to another component or indirectly connected to other component on the piece.

In the context of the specification, the terms “first’, “second” and “third” are only used for descriptive purpose and does not implicate the relative importance or to implicitly indicate the quantity of technical features indicated.

In the context of the specification, the term “plurality” means two or more than two, unless otherwise indicated.

In the context of the specification, the term “several” means more than one, unless otherwise specified.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 shows a valve.

FIG. 2 is a flow chart showing method for detecting seat leakage of a valve in accordance with an embodiment of the present invention.

FIG. 3 is an apparatus for detecting seat leakage of a valve in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose a method to reliably measure the seat leakage in a pneumatic seat test of valves. The method comprises filling the non-pressurized cavity of the valve under test with water, and connecting a jar or beaker to it using a conduit. The conduit is filled with water up to the point where the leakage measuring jar is located. During the pneumatic seat test, the presence of water in the valve cavity facilitates the formation of bubbles as a result of seat leakage. As the bubbles form, the bubbles displace the water, forming drops at the end of the conduit. The drops are then collected in the measuring jar to measure the overall volume of leakage during the test duration.

In another embodiment, a system for measuring seat leakage in a pneumatic seat test of valves. The apparatus comprises a first blind flange mounted on a test table that seals the first opening of a valve; a second blind flange to seal the second opening of the valve. The second blind flange is coupled mechanically using fasteners, hydraulically or by other suitable means. The first blind flange has a passage to introduce pressurized air or gas into the valve cavity. The second blind flange has a provision to connect a conduit through a connector. The other end of the conduit opens into a container.

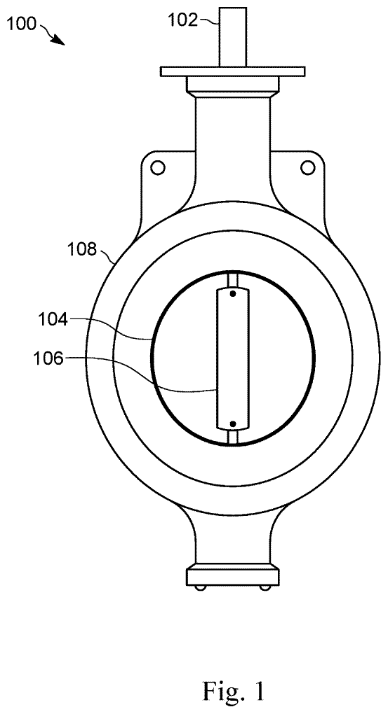

Several embodiments of the present invention will now be described in detail with references to FIGS. 1-3.

Referring to FIG. 1, a valve with different component is shown. The valve 100 includes a body 108, a stem 102, a disc 106, and a seat 104. As can be seen from FIG. 1, the seat 104 is positioned around the internal perimeter of flow passage. During installation, seat 104 can be compressed or folded and inserted into the body 108. The seat 108 has an internal face that serves to seat the edges of the disc 106 of the valve 100 when the disc 106 is rotated to a close position. The seat 108 has a pair of opposing holes to allow the stem 102 of the valve 100 to be inserted there through. The valve 100 includes a disc 106, preferably made of stainless steel, for providing a positive seal against the internal face of the seat 108 when the disc 106 is rotated to a close position. The stem 102 is mechanically connected to the disc 106 using fastener, bolts or any suitable means. The stem 102 of the valve 100 is rotated to rotate the disc 106 in order to close or open the valve. During the close state, any flow across the sides of the valve 100 is stopped.

The above figure depicts the valve as a butterfly valve, however, the person skilled in the art will understand that the apparatus and method described herein are suitable for testing other types of valves as well.

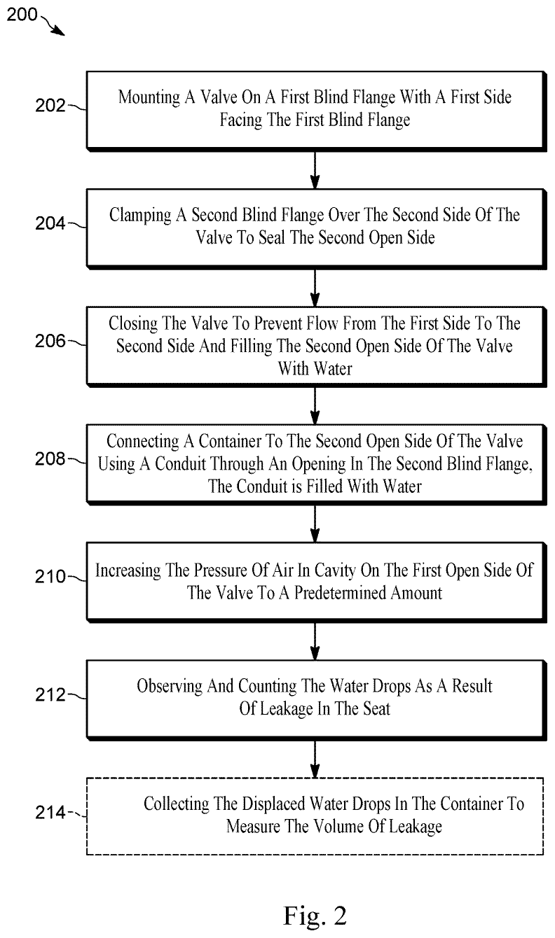

FIG. 2 is a flow chart showing method for detecting seat leakage of a valve in accordance with an embodiment of the present invention. In the first step 202, the valve 100 is mounted on a first blind flange such that one side opening of the valve is facing the first blind flange. The valve 100 is secured and fixed on the first blind flange using fasteners, bolts, or any mechanical or hydraulic means. The valve is fixed on the first blind flange so that the valve is in air tight contact with the first blind flange. The first blind flange has a passage to introduce pressurized air into the valve cavity on the first open side of the valve.

In the next step 204, the valve 100 is closed by rotating the stem 102 of the valve. In the closed state, the perimeter of the disc 106 of the valve engages with the seat.

In the next step 206, the second side of the valve 100 is sealed with a second blind flange. The second blind flange is clamped on the second open side of the valve 100 mechanically using fasteners, bolts, or hydraulically or by other suitable means. The water is filled in a valve cavity between the second blind flange and the second side of the valve 100.

In the next step 208, a container is connected to the second open side of the valve using a conduit and then the conduit is filled with water. The conduit is connected to the second open side of the valve through an opening in the second blind flange.

In the next step 210, the pressure of air is increased to a predetermined amount in the cavity on the first open side of the valve. The pressure is increased by introducing pressurized air through the passage on the first blind flange.

In the next step 212, the water drops due to leakage in the seat are observed and counted. When the pressurized air or gas leaks past the disc of the valve due to the pressure created at the opposite end, small bubbles are formed due to presence of water above the disc. The formation of the bubbles cause the water to displace and thus the water is pushed through the conduit. This creates drops at the end of the conduit which is collected in a container. The drops can be counted visually or using an instrument to measure the leakage.

In the next step 214, the displaced water drops is collected in a graduated container. The total leakage during the test time is determined from the water level in the graduated container.

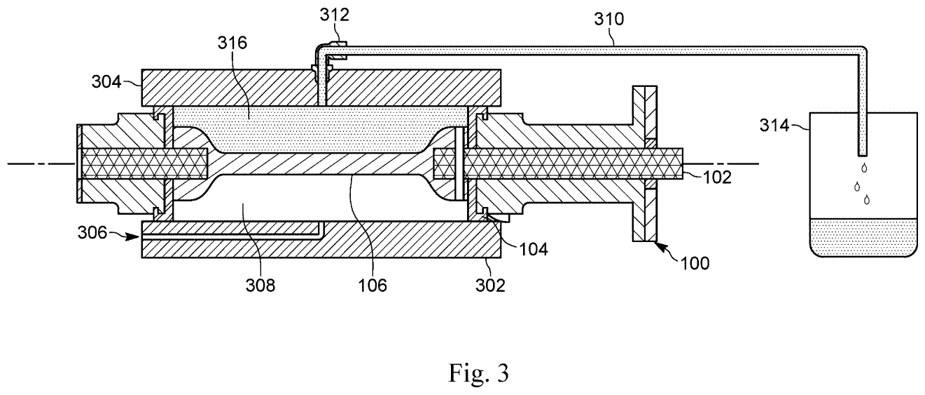

FIG. 3 is an apparatus for detecting seat leakage of a valve in accordance with an embodiment of the present invention. The apparatus comprises a first blind flange 302 having a passage 306 for introducing pressurized air or gas. The first blind flange 302 is used for mounting a valve 100, such that a first open side of the valve 100 is sealed against the first blind flange 302. The valve 100 when placed over the first blind flange 302 has the seat 104 in air-tight contact with the first blind flange 302. The passage 306 in the first blind flange 302 opens into a cavity 308 created between the first open side of the valve and the first blind flange 302. When the stem 102 of the valve is rotated, the disc 106 engages with seat 104, thereby closing valve 100. The passage 306 is connected to a pressure system that introduce pressurized air through the passage 306 into the cavity 308.

The apparatus further comprises a second blind flange 304 to seal the opening on the second open side of the valve. The second blind flange 304 is clamped mechanically to the second open side of the valve 100 using fasteners, bolts, or hydraulically or by other suitable means. The second blind flange 304 has a provision to fill water in a valve cavity 316 between the second blind flange 304 and the second open side of the valve. The one end of the opening in the second blind flange has a provision 312 to connect to a conduit 310. The conduit 310 opens into a container 314.

When the disc 106 of the valve 100 is closed, water is filled in the valve cavity 316 above the disc 106 and in the conduit 310 connecting the second blind flange 304 and the container 314. Pressurized air or gas from the pressure system is passed into cavity 308 through the passage 306 provided in the first blind flange 302. This creates pressure to build up in cavity 308 below the disc 106 in the valve 100.

If there is seat leakage in the valve, the pressurized air or gas leaks past the disc 106 and bubbles are formed due to the water present above the disc 106. The formation of bubbles causes the water to displace and thus pushes the water through the conduit 308. This creates drops at the end of the conduit 308 which is collected in the container 314. These drops can be counted visually or using an instrument to measure the leakage in drops per minute.

In an alternate embodiment, the container 314 is a graduated container and the volume of the drops collected in the container can be used to determine the amount of leakage in the seat during seat testing of valve.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A method for detecting and measuring seat leakage of a valve, comprising:
mounting a first open side of the valve on a first blind flange, the first blind flange has a passage for introducing pressurized air on the first open side of the valve;
clamping a second blind flange over the second open side of the valve to seal the second open side;
closing the valve to prevent flow from the first side to the second side;
filling the second open side of the valve with water;
connecting a container to the second open side of the valve using a conduit through an opening in the second blind flange, the conduit is filled with water;
increasing the pressure of air in cavity on the first open side of the valve to a predetermined amount;
observing and counting the water drops as a result of leakage in the seat, where one or more bubbles created due to leakage in the seat, displace the water in the conduit and form drops at the end of the conduit.

2. The method of claim 1, wherein the conduit is filled with water up to a point where the leakage measuring container is located.

3. The method of claim 1, wherein when the pressurized air leaks past the valve, bubbles are formed due to the water present on the second side of the valve.

4. The method of claim 3, wherein the bubbles cause the water to displace and push the water through the conduit.

5. The method of claim 4, wherein the displaced water creates drops at the end of the conduit, the drops are collected in the container.

6. The method of claim 5, wherein the drops are counted visually or using an instrument to measure the leakage.

7. The method of claim 1, wherein the measurement of overall volume of leakage is performed using a graduated container.

8. An apparatus for detecting and measuring seat leakage of a valve comprising:
a first blind flange for sealing a first opening on a first side of the valve;
a second blind flange for sealing a second opening on a second side of the valve, wherein cavity in the second opening at the second side of the valve is filled with water;
a passage in the first blind flange to introduce pressurized air on the first side of the valve;
a pressure system connected to the passage for increasing the pressure of air to a predetermined amount;
a container connected to the second side of the valve using a conduit through an opening in the second blind flange, the conduit is filled with water;
wherein seat leakage results in formation of bubbles that displaces the water and form drops at the end of the conduit.

9. The apparatus of claim 8, wherein the valve comprises a shaft to put the valve in closed state.

10. The apparatus of claim 8, wherein the first blind flange and the second blind flange seals the valve when the valve is in closed state.

11. The apparatus of claim 8, wherein the second blind flange is clamped at the second side of the valve mechanically using a fastener or hydraulically.

12. The apparatus of claim 8, wherein the drops at the end of the conduit are measured to determine the seat leakage of the valve.
